(19) United States
(12) Patent Application Publication
(10) Pub. No.: US 2011/0199705 A1
(43) Pub. Date: Aug. 18, 2011

(54) DISK DRIVE ACTUATOR INERTIAL LATCH WITH MOMENT OF INERTIA AND MAGNETIC ATTRACTION PRODUCT RELATIONSHIP

(75) Inventor: Hirofumi NESORI, Fuchu-shi (JP)

(73) Assignee: KABUSHIKI KAISHA TOSHIBA, Tokyo (JP)

(21) Appl. No.: 13/096,893

(22) Filed: Apr. 28, 2011

Related U.S. Application Data
(63) Continuation of application No. 12/551,321, filed on Aug. 31, 2009.

(30) Foreign Application Priority Data
Dec. 12, 2008 (JP) 2008-317380

(51) Int. Cl. G11B 17/02

(52) U.S. Cl. 360/99.08; G9B/17.002

(57) ABSTRACT

According to one embodiment, a disk drive includes a carriage supporting a head configured to perform information processing for the recording medium, and a latch mechanism configured to latch and hold the carriage in a retracted position when an external force acts on the disk drive with the carriage being in the retracted position. The latch mechanism includes a latch member pivotable around an central axis between a latchable range and a released position. The latch member is configured to pivot in a latching direction within the latchable range before the engaging portion of the carriage starts to move when a rotational impact externally acts in a direction to pivot the carriage toward the information processing position with the carriage and the latch member being located in the retracted position and the latchable range, respectively.

### CROSS-REFERENCE TO RELATED APPLICATIONS

This application is a continuation of U.S. patent application Ser. No. 12/551,321, filed Aug. 31, 2009, which is based upon and claims the benefit of priority from Japanese Patent Application No. 2008-317380, filed Dec. 12, 2008, the entire contents of each of which are incorporated herein by reference.

### BACKGROUND

1. Field

An embodiment of the invention relates to a disk drive provided with a latch mechanism for a carriage.

2. Description of the Related Art

In recent years, magnetic disk devices, for example, have been widely used as high-capacity disk devices in electronic apparatuses, such as personal computers. In general, a magnetic disk device is provided with a magnetic disk, spindle motor, pivotable carriage, voice coil motor (VCM), board unit, etc. The magnetic disk is disposed in a case. The spindle motor supports and rotates the disk. The carriage supports a magnetic head. The VCM is composed of a voice coil, which is mounted on the carriage, and a pair of yokes and permanent magnet mounted on the case side.

Further, small, portable personal computers have recently been spreading, and magnetic disk devices mounted in the personal computers of this type are expected to be improved in reliability against impact or the like while being carried around.

Thereupon, a magnetic disk device with a ramp load mechanism is proposed. The ramp load mechanism includes a ramp disposed outside the magnetic disk. When the magnetic disk device is non-operational, the carriage is pivoted to a retracted position at the outer periphery of the disk, and a suspension mounts the ramp. Thus, the magnetic head is kept apart from a surface of the disk.

Further, proposed in Jpn. Pat. Appln. KOKAI Publication No. 2005-235375, for example, is a magnetic disk device of this type, which is provided with a latch mechanism for additionally improving the impact resistance. If the magnetic disk device is jolted when it is non-operational, the latch mechanism engages with the carriage to prevent its pivoting motion and holds the carriage in the retracted position.

The latch mechanism is provided with a latch arm that includes a latch hook. The latch arm is movable between a latched position where it can engage with the carriage and a released position where the carriage is unlatched. When the carriage is moved to the retracted position, it contacts a contact portion of the latch arm and causes the arm to move from the released position to the latched position. Then, the latch arm abuts a stop and is held in the latched position. At the same time, the carriage is held in the retracted position with the latch arm used as a stop. Thus, if the magnetic disk device is jolted, the latch arm latches the carriage to inhibit its locking motion, thereby preventing unexpected movement of the carriage.

In the latch mechanism constructed in this manner, the carriage contacts the latch arm when the magnetic disk device is non-operational, and the latch arm itself serves as a stop. Depending on the duration and magnitude of a rotational impact that acts in the direction to pivot the magnetic head toward the magnetic disk, therefore, the latch arm may rebound and pivot away from the engagement side and escape from the position where it can engage with the carriage. In this case, the latch arm may fail to engage with the carriage, so that the head may jump out onto the disk, depending on the timing for the pivoting motion of the carriage attributable to the rotational impact. In consequence, the magnetic disk device may be damaged.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view showing an HDD according to an embodiment of the invention;

FIG. 2 is an exemplary enlarged plan view showing a part of the HDD;

FIG. 3 is an exemplary enlarged plan view showing a latch mechanism of the HDD with its latch member in a latched position;

FIG. 4 is an exemplary enlarged plan view showing the latch mechanism of the HDD with the latch member in a released position;

FIG. 5 is an exemplary plan view showing the positional relationship between a trajectory of a latch hook and that of an engaging hook of a carriage;

FIG. 6 is an exemplary plan view showing the directions of torques and magnetic attractions generated in the carriage and a latch arm when an external rotational impact is applied in a non-operational state;

FIG. 7 is an exemplary diagram showing a magnetic attraction acting on the latch arm in each position of the distal end of the latch hook of the latch arm;

FIG. 8 is an exemplary diagram showing a magnetic attraction acting on the carriage in each position of the distal end of the engaging portion of the carriage;

FIG. 9 is an exemplary diagram showing an example of the waveform of the external rotational impact;

FIGS. 10A and 10B are exemplary diagrams showing timings for the latch arm and carriage to start moving when the external rotational impact is applied; and

FIG. 11 is an exemplary plan view showing how the carriage is turned by the rotational impact and latched.

### DETAILED DESCRIPTION

Various embodiments according to the invention will be described hereinafter with reference to the accompanying drawings. In general, according to one embodiment of the invention, a disk drive comprises a disk recording medium; a drive motor arranged on a base and configured to support and rotate the recording medium; a carriage supporting a head configured to perform information processing for the recording medium, the carriage being arranged on the base to be pivotable around a central axis between a retracted position where the head is located on an outer peripheral side of the recording medium and an information processing position where the head is located on the recording medium; a first magnetic attraction portion provided on the carriage and configured to urge the carriage toward the retracted position; a fixing stop provided on the base and configured to contact and position the carriage in the retracted position when the carriage is moved to the retracted position; and a latch mechanism configured to latch and hold the carriage in the retracted position when an external force acts on the disk drive with the carriage being in the retracted position. The latch mechanism comprises an engaging portion provided on the carriage, a latch member arranged on the base to be pivotable around an central axis between a latchable range in which the latch member is latchable the engaging portion of the carriage and a released position in which the latch member is deviated from a movement path of the engaging portion to unlatch the engaging portion, and a second magnetic attraction portion provided on the latch member and configured to urge the latch member toward the released position, the carriage and the latch member being formed so as to satisfy Tb·Jc≦Tm·Jl, where Jc is the moment of inertia of the carriage, Jl is the moment of inertia of the latch member, Tb is the magnetic attraction of the second magnetic attraction portion, and Tm is the magnetic attraction of the first magnetic attraction portion. The latch member is configured to pivot in a latching direction within the latchable range before the engaging portion of the carriage starts to move when a rotational impact externally acts in a direction to pivot the carriage toward the information processing position with the carriage and the latch member being located in the retracted position and the latchable range, respectively.

A hard disk drive (HDD) according to an embodiment of this invention will now be described in detail with reference to the accompanying drawings.

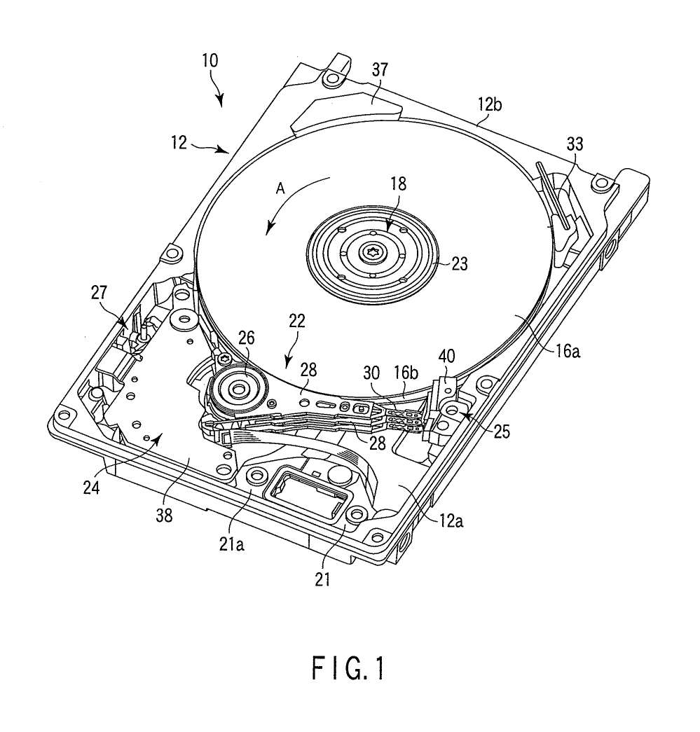

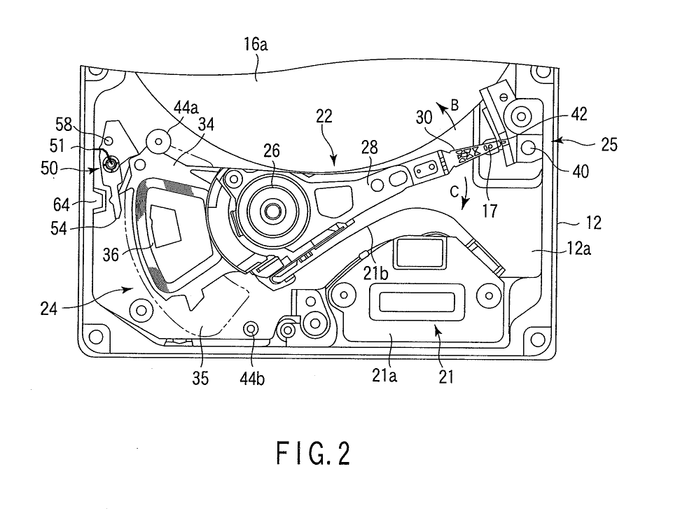

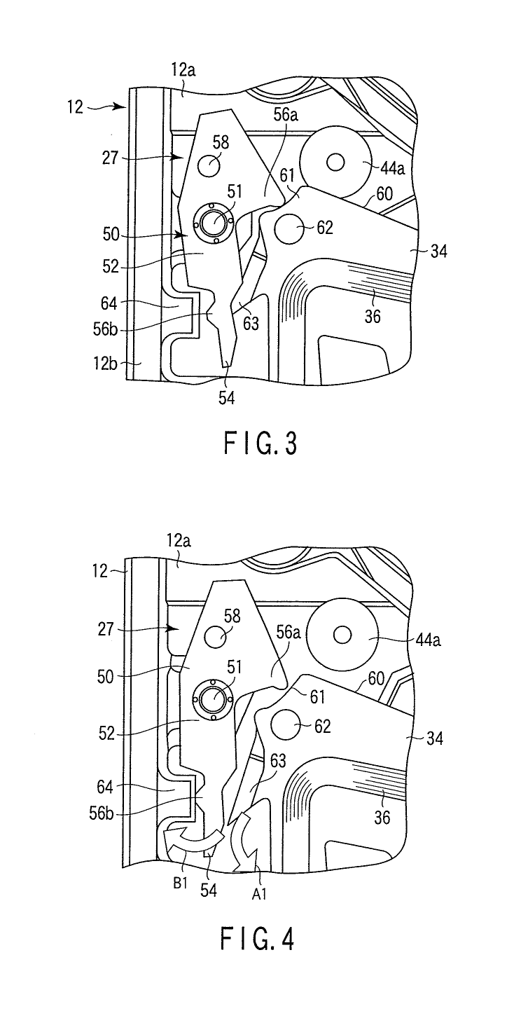

FIG. 1 shows the internal structure of the HDD with its top cover removed, and FIG. 2 shows a carriage and latch mechanism section of the HDD. FIG. 3 is an enlarged view of a latch mechanism. As shown in FIGS. 1 and 2, the HDD is provided with a case 10. The case 10 includes a base 12 in the form of an open-topped rectangular box and a top cover (not shown), which is fastened to the base by screws so as to close a top opening of the base. The base 12, which functions as a pedestal, includes a rectangular bottom wall 12a and sidewall 12b set up along the peripheral edge of the bottom wall.

The case 10 contains a spindle motor 18 for use as a drive motor and two magnetic disks 16a and 16b. The motor 18 is mounted on the bottom wall 12a. The disks 16a and 16b are supported and rotated by the spindle motor 18. The case 10 further contains a plurality of magnetic heads 17, carriage 22, voice coil motor (VCM) 24, ramp load mechanism 25, latch mechanism 27, and board unit 21. The magnetic heads 17 record and reproduce information on and from the magnetic disks 16a and 16b. The carriage 22 supports the heads 17 for movement with respect to the disks 16a and 16b. The VCM 24 pivots and positions the carriage 22. The ramp load mechanism 25 holds the magnetic heads 17 in a retracted position at a distance from the magnetic disks 16a and 16b when the heads 17 are moved to the outermost peripheries of the disks. The latch mechanism 27 holds the carriage 22 in its retracted position when the HDD is jolted. The board unit 21 includes a preamplifier and the like.

A printed circuit board (not shown) is screwed to the outer surface of the bottom wall 12a of the base 12. The circuit board controls operations of the spindle motor 18, VCM 24, and magnetic heads 17 through the board unit 21. The HDD is provided with a circulation filter 33 and intake filter 37. The circulation filter 33 is used to remove dust in the case 10. The intake filter 37 serves to capture dust and the like from the open air that is drawn into the case 10 from outside.

Each of the magnetic disks 16a and 16b for use as recording media is formed with a diameter of, for example, 65 mm (2.5 inches) and has magnetic recording layers on its upper and lower surfaces, individually. The two disks 16a and 16b are coaxially fitted on a hub (not shown) of the spindle motor 18 and clamped and fixed on the hub by a clamp spring 23. Thus, the disks 16a and 16b are supported parallel to the bottom wall 12a of the base 12. The disks 16a and 16b are rotated at a predetermined speed of, for example, 5,400 or 7,200 rpm in the direction of arrow A by the spindle motor 18 as a drive section.

As shown in FIGS. 1 and 2, the carriage 22 is provided with a bearing 26 fixed on the bottom wall 12a of the base 12 and four arms 28 extending from the bearing. The bearing 26 is spaced apart from the center of rotation of the magnetic disks 16a and 16b, longitudinally relative to the base 12, and is located near the outer peripheral edges of the disks. The four arms 28 are located parallel to the surfaces of the disks and at predetermined spaces from one another and extend in the same direction from the bearing 26. The carriage 22 is provided with elastically deformable suspensions 30 each in the form of an elongated plate. Each suspension 30 is formed of a leaf spring, the proximal end of which is fixed to the distal end of its corresponding arm 28 by spot welding or adhesive bonding and extends from the arm. Each suspension 30 may be formed integrally with its corresponding arm 28.

Each magnetic head 17 is mounted on an extended end of each corresponding suspension 30. The head 17 includes a substantially rectangular slider and read/write magnetoresistive (MR) head formed on the slider. The head 17 is fixed to a gimbal portion that is formed on the distal end portion of the suspension 30. Each two of the four magnetic heads 17 that are mounted individually on the suspensions 30 are located opposite each other so as to sandwich each of the magnetic disks 16a and 16b from both sides.

The carriage 22 includes a support frame 34 that extends from the bearing 26 so as to be oriented opposite from the arms 28. The support frame supports a voice coil 36 that constitutes a part of the VCM 24. The frame 34 is a plastic structure that is molded integrally on the outer periphery of the voice coil 36. The voice coil 36 is located between a pair of yokes 38 fixed on the base 12. The voice coil 36, along with these yokes and a magnet 35 fixed to one of the yokes, constitute the VCM 24.

If the voice coil 36 is energized, the carriage 22 pivots around the bearing 26 between a retracted position and information processing position. In the retracted position, the magnetic heads 17 are located off the magnetic disks 16a and 16b on the outer peripheral side thereof. In the information processing position, the heads 17 are located on the disks 16a and 16b. Specifically, the carriage 22 is pivoted in the direction of arrow B (loading direction) and direction of arrow C (unloading direction) around the bearing 26. Thereupon, the magnetic heads 17 are moved to and positioned on desired tracks of their corresponding magnetic disks 16a and 16b. Thus, the heads 17 can write or read information to or from the disks 16a and 16b. The carriage 22 and VCM 24 constitute a head actuator.

A first fixing stop 44a and second fixing stop 44b, each in the form of a pin, are set up on the bottom wall 12a. The first fixing stop 44a is located in a position where it abuts against the support frame 34 of the carriage 22 when the carriage is pivoted to the retracted position. Thus, the first fixing stop 44a keeps the carriage 22 from excessively moving toward the retracted position of the carriage, that is, in the unloading direction C. The second fixing stop 44b is located in a position where it abuts against the support frame 34 when the carriage 22 is pivoted to the innermost peripheral side of the magnetic disks 16a and 16b. Thus, the second fixing stop 44b keeps the carriage 22 from excessively moving toward the information processing position of the carriage, that is, in the loading direction B. The first and second fixing stops 44a and 44b are made elastic in order to absorb impact when they contact the support frame 34. For example, the respective surfaces of the first and second fixing stops 44a and 44b are covered by an elastic material, such as synthetic resin or rubber.

As shown in FIGS. 2 and 3, the support frame 34 of the carriage 22 is formed with a stop contact surface 60 and latch contact portion 61. The stop contact surface 60 functions as a stop contact portion that contacts the first fixing stop 44a. The latch contact portion 61 contacts a latch arm (mentioned later) of the latch mechanism 27. A first magnetic attraction portion 62 of a magnetic material, such as stainless steel, is formed near the latch contact portion 61 on the support frame 34. The first magnetic attraction portion 62 is magnetically attracted by the magnet 35 of the VCM 24 or the lower yoke and urges the carriage 22 toward the retracted position, that is, to contact the first fixing stop 44a. Further, an outwardly projecting engaging hook 63 is formed near the latch contact portion 61 on the support frame 34. The engaging hook 63 constitutes a part of the latch mechanism 27.

As shown in FIGS. 1 and 2, the ramp load mechanism 25 includes a ramp 40 arranged on the bottom wall 12a of the base 12 and located outside the magnetic disks 16a and 16b and tabs 42 that extend individually from the respective distal ends of the suspensions 30. The ramp 40 is located on the downstream side of the bearing 26 with respect to a direction of rotation A of the disks 16a and 16b. When the carriage 22 pivots so that the magnetic heads 17 are pivoted to the retracted position outside the disks 16a and 16b, each tab 42 engages with a ramp surface formed on the ramp 40 and is then pulled up along the slope of the ramp surface to unload the heads 17.

The board unit 21 has a main body 21a, which is formed of a flexible printed circuit board and fixed on the bottom wall 12a of the base 12. Electronic components, including a head amplifier, are mounted on the body 21a. The board unit 21 includes a main flexible printed circuit board (main FPC) 21b extending from the body 21a. An extended end of the main FPC 21b is connected to the vicinity of the bearing 26 of the carriage 22. Further, the extended end is electrically connected to the magnetic heads 17 by cables (not shown) on the arms 28 and suspensions 30. Connectors (not shown) for connection with the printed circuit board are mounted on the bottom surface of the body of the board unit 21.

As shown in FIGS. 2 and 3, the latch mechanism 27 includes a plate-like latch arm 50 and the engaging hook 63. The latch arm 50 is disposed on the bottom wall 12a of the base 12 in the vicinity of the support frame 34 of the carriage 22. The engaging hook 63 projects from the support frame 34 of the carriage 22. The latch arm 50 that functions as a latch member includes a support portion 52 in its central part. The support portion is pivotably supported on the bottom wall 12a by a pivot 51. The latch arm 50 is an integrally molded structure of synthetic resin or the like, which includes a latch hook 54, first contact portion 56a, and second contact portion 56b. The latch hook 54 extends from the support portion and can engage with the engaging hook 63 of the support frame 34. The first contact portion 56a extends substantially at right angles to the latch hook 54 from the support portion and can contact the latch contact portion 61. The second contact portion 56b can contact a latch stop 64 formed on the base 12.

The latch arm 50 is supported for pivoting motion around the pivot 51 between an illustrated latched position and released position. In the latched position, the latch hook 54 is located in a movement path of the engaging hook 63 of the support frame 34 and can latch the carriage 22. In the released position, the carriage 22 is unlatched and allowed to pivot.

The second contact portion 56b of the latch arm 50 is disposed nearer to the latch hook 54 than the support portion 52. The latch stop 64 keeps the latch arm 50 from excessively pivoting toward the released position. In the released position, the second contact portion 56b of the latch arm 50 contacts the latch stop 64, thereby keeping the latch arm 50 from pivoting. Further, the latch arm 50 is kept from excessively pivoting toward the latched position as the latch hook 54 contacts the outer peripheral surface of the support frame 34.

The latch arm 50 includes a second magnetic attraction portion 58 that is disposed on the opposite side of the support portion 52 from the latch hook 54. The second magnetic attraction portion 58 is composed of a spherical magnetic material of stainless steel or the like embedded in the latch arm 50. The second magnetic attraction portion 58 is magnetically attracted by the magnet 35 of the VCM 24 or the lower yoke and urges the latch arm 50 toward the released position so that the first contact portion 56a contacts the support frame of the carriage 22.

If the HDD is subjected to an impact or any other external force when its operation is stopped, the latch mechanism 27 constructed in this manner uses an inertial force of the latch arm 50 and a magnetic attraction thereon to latch the carriage 22 that is moved to the retracted position. Thus, the carriage is prevented from moving from the retracted position to the information processing position.

FIG. 3 shows the carriage 22 and latch mechanism 27 of the HDD in a non-operational state. If the carriage 22 is pivoted from the information processing position to the illustrated retracted position when the HDD is non-operational, the stop contact surface 60 of the support frame 34 contacts the first fixing stop 44a. Further, the first magnetic attraction portion 62 of the support frame 34 is magnetically attracted by the magnet 35, whereupon the carriage 22 is held in the illustrated retracted position where the stop contact surface 60 contacts the first fixing stop 44a. Since the first fixing stop 44a is elastic, it can absorb impact and reduce collision noise when it is hit by the support frame 34.

When the carriage 22 is pivoted to the retracted position, the latch contact portion 61 of the support frame 34 contacts and presses the first contact portion 56a of the latch arm 50. Thereupon, the latch arm 50 pivots counterclockwise around the pivot 51 and moves to the illustrated latched position. As this is done, the latch arm 50 is urged clockwise around the pivot 51 by the magnetic attraction of the first magnetic attraction portion 62, so that it is pivoted with the first contact portion 56a pressed against the latch contact portion 61 of the support frame 34 and is held in the latch position. The latch arm 50 is kept from rotating clockwise by the magnetic force of the second magnetic attraction portion 58. In the latched position, the latch arm 50 is positioned by contact with the carriage 22 only and is not in contact with any other parts of the base 12 than the region around the pivot 51.

When the latch arm 50 is held in the latched position, the latch hook 54 is located in the movement path of the engaging hook 63 of the support frame 34 in the vicinity of the hook 63 and can latch the hook 63.

FIG. 4 shows how the latch arm 50 and carriage 22 act when the magnetic heads are loaded into the HDD in operation. The carriage 22 is pivoted in the loading direction B by the second housing 24, whereupon the magnetic heads 17 are loaded onto the magnetic disks 16a and 16b. In FIG. 4, arrow A1 indicates a motion of the engaging hook 63 on the support frame 34 of the carriage 22 during this operation. When the carriage 22 starts to pivot in the loading direction B, the latch contact portion 61 of the support frame 34 is induced to separate from the first contact portion 56a of the latch arm 50. Thereupon, the latch arm 50 is released from the restriction on movement by the latch contact portion 61, and the second magnetic attraction portion 58 is magnetically attracted by the magnet 35 of the second housing 24. By this magnetic attraction, the latch arm 50 is pivoted clockwise around the pivot 51 so that the second contact portion 56b contacts the latch stop 64, and is held in the illustrated released position. The motion of the distal end of the latch hook 54 is indicated by arrow B1 in FIG. 4. In the released position, the latch hook 54 of the latch arm 50 is kept apart from the engaging hook 63 on the support frame 34 and located off the movement path of the engaging hook 63. Thus, the engaging hook 63 cannot engage with the latch hook 54, so that the carriage 22 is allowed to pivot, and the magnetic heads 17 can be loaded onto the magnetic disks 16a and 16b. If the magnetic attraction of the second magnetic attraction portion 58 of the latch arm 50 is insufficient, however, the latch arm may fail to be opened.

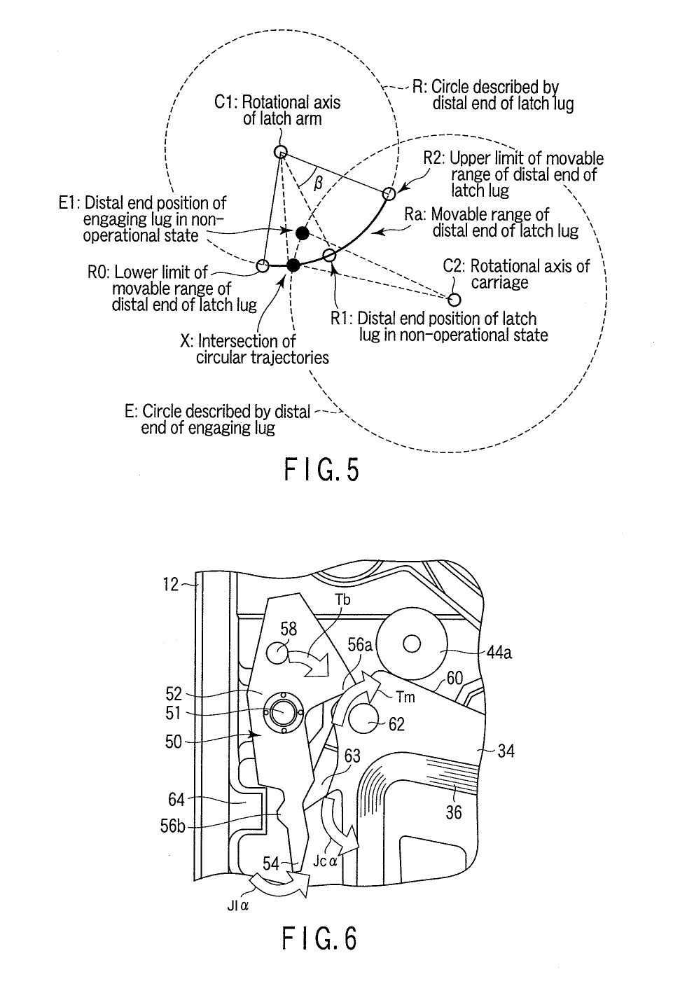

FIG. 5 shows the positional relationship between a trajectory R of the latch hook 54 and a trajectory E of the engaging hook 63. The distal end positions of the latch hook 54 and engaging hook 63 of the non-operational HDD shown in FIG. 3 are designated by R1 and E1, respectively. The distal end of the latch hook 54 describes the trajectory R along a circle around a rotational axis C1 of the latch arm 50, and the engaging hook 63 describes the trajectory E along a circle around a rotational axis C2 of the carriage 22. The distal end position R1 of the latch hook 54 in the non-operational state exists inside the trajectory E of the distal end of the engaging hook 63. The distal end of the latch hook 54 can move within a range from a lower limit R0 to upper limit R2 such that the second contact portion 56b of the latch arm 50 contacts the latch stop 64.

When the first contact portion 56a of the latch arm 50 separates from the latch contact portion 61 of the carriage 22, the latch hook 54 starts to be pivoted clockwise by the magnetic attraction of the second magnetic attraction portion 58. The engaging hook 63 can be latched, since the latch hook 54 exists inside the trajectory E of the engaging hook 63, within a range between the upper limit R2 of the movable range and a critical latching point, that is, an intersection X of the circular trajectories R and E. Thus, if the first contact portion 56a and latch contact portion 61 are separated by an external impact in the non-operational state, the latch mechanism functions or latches and prevents the carriage from unexpectedly pivoting when the distal end of the engaging hook 63 reaches the intersection X of the circular trajectories before the distal end of the latch hook 54 goes to the outside of the circular trajectory E of the engaging hook 63 beyond the intersection X of the trajectories. In the movable range of the latch hook 54, the angle between the upper limit R2 and the distal end position R1 of the latch hook in the non-operational state is set to 5 to 30 degrees, preferably 10 to 30 degrees.

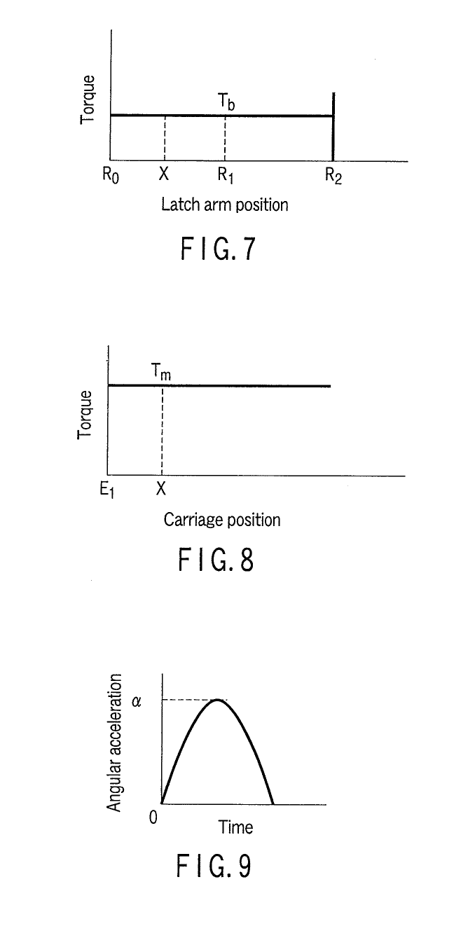

The following is a description of an operation of the latch mechanism of the HDD in the non-operational state performed when a rotational impact acts in the direction to cause the carriage 22 externally to pivot in the loading direction B, that is, in a direction (first direction) in which the magnetic heads 17 are loaded onto the magnetic disks 16a and 16b. FIG. 6 shows operations of the latch arm 50 and carriage 22 performed when the rotational impact acts in the first direction in the non-operational state. FIG. 7 shows the movable range of the distal end of the latch hook 54 of the latch arm 50 and an example of magnetic attraction (torque) that acts on the latch arm in each position. FIG. 8 shows the movable range of the distal end of the engaging hook 63 of the carriage 22 and an example of magnetic attraction (torque) that acts on the carriage in each position. In the present embodiment, as shown in FIGS. 7 and 8, a magnetic attraction in one position is hardly different from one in another position.

Now let us suppose that the external rotational impact can be represented by a half-sine wave based on a maximum angular acceleration α, as shown in FIG. 9. A first direction of torques and angular accelerations that act on the latch arm 50 and carriage 22 is supposed to be positive, and a second direction opposite to the first direction as negative.

When the HDD is non-operational, the carriage 22 is held in the retracted position, while the latch arm 50 is held in the latched position that is settled by the first contact portion 56a and latch contact portion 61. In this state, the distal end of the latch hook 54 of the latch arm 50 is located in the position R1 of FIG. 5, and that of the engaging hook 63 of the carriage 22 in the position E1 of FIG. 5.

When the carriage 22 is in the retracted position, a magnetic attraction Tm of the first magnetic attraction portion 62 in the second direction acts on the carriage 22, as shown in FIGS. 6 and 8. If a rotational impact is applied, an inertial force (torque) is generated such as to pivot the carriage 22 oppositely or in the first direction, resisting the magnetic attraction Tm. If the moment of inertia and angular acceleration of the carriage 22 are Jc and θc, respectively, the equation of motion of the carriage 22 can be given as follows:

Jcθc=Jcα−Tm.

If the angular acceleration θc is negative, no angular acceleration is generated in the direction in which the magnetic heads 17 pivot toward the magnetic disks 16a and 16b, so that the carriage 22 cannot pivot. If the angular acceleration θc is positive, however, the carriage 22 starts to pivot in the first direction. In this case, the maximum angular acceleration for Jcα=Tm is α0 (=Tm/Jc). If the maximum angular acceleration a becomes higher, the amount of swing of the carriage 22 increases and the distal end of the engaging hook 63 starts to reach the intersection X of the circular trajectory E. The maximum angular acceleration of a rotational impact that causes the engaging hook 63 to start reaching the intersection X of the trajectory E is given by αx.

On the other hand, in order for the latch arm 50 to prevent the carriage 22 from pivoting, as mentioned before, the distal end of the latch hook 54 should be located inside the circular trajectory E described by the distal end of the engaging hook 63. In the latched position, a magnetic attraction Tb of the second magnetic attraction portion 58 in the second direction acts on the latch arm 50. If a rotational impact in the first direction is applied, a similar rotational impact also acts on the latch arm 50. Specifically, the latch arm 50 is subjected to a clockwise inertial force around the pivot 51. If the moment of inertia and angular acceleration of the latch arm 50 are Jl and θl, respectively, the equation of motion of the latch arm 50 can be given as follows:

Jlθl=Jlα−Tb.

The latch arm 50 behaves in the following various manners, depending on the maximum angular acceleration a of the rotational impact acting on the HDD.

(1) Case of α≦α0:

The carriage 22 does not pivot. If the angular acceleration θl is positive, the latch arm 50 starts to pivot in the first direction from the latched position. If the angular acceleration θl is negative, the first contact portion 56a is in contact with the latch contact portion 61 of the carriage 22, so that the latch arm 50 cannot pivot in the second direction from the latched position.

(2) Case of α0<α<αx:

Although the carriage 22 starts to pivot, the distal end of the engaging hook 63 does not reach the intersection X of the circular trajectories. If the angular acceleration θl is positive, the latch arm 50 starts to pivot in the first direction from the latched position. If the angular acceleration θl is negative, the latch arm 50 starts to pivot in the second direction, and the first contact portion 56a and latch contact portion 61 contact each other and pivot following the carriage 22.

(3) Case of αx≦α:

The carriage 22 starts to pivot, and the distal end of the engaging hook 63 reaches the intersection X of the circular trajectories. If the angular acceleration θ1 is negative, the latch arm 50 starts to pivot in the second direction. Possibly, therefore, the distal end of the latch hook 54 may escape from inside the circular trajectory E described by the distal end of the engaging hook 63 before the distal end of the engaging hook 63 reaches the intersection X of the circular trajectory E. Thus, in some cases, the engaging hook 63 may reach the intersection X of the circular trajectory E, thereby causing faulty engagement, when the distal end of the latch hook 54 is moved from the lower limit R0 of the movable range at which it cannot engage with the engaging hook 63 into the range of the intersection X of the circular trajectory R.

If the angular acceleration θl is positive, the carriage 22 pivots in the first direction or toward the engagement side from the latched position. When compared with the case where the angular acceleration θl is negative, therefore, the distal end of the latch hook 54 is located in the range of the upper limit R2 for a longer time, moved from the intersection X of the circular trajectory R at which it can engage with the engaging hook 63, so that the possibility of faulty engagement is lower.

Accordingly, the higher the moment of inertia Jl of the latch arm 50, the more easily the torque Jlα exceeds the magnetic attraction Tb that acts on the latch arm 50, which is a desirable consequence. If the moment of inertia Jl is unduly increased, however, it influences the way the latch arm 50 is opened as the magnetic heads 17 are loaded during the operation of the HDD. Thus, during the operation, the excessively high moment of inertia Jl hinders the pivoting motion of the latch arm 50, so that the possibility of failure of the opening operation may be increased. In consequence, the magnetic attraction Tb and moment of inertia Jl of the latch arm 50 must be designed appropriately.

If the angular acceleration θl of the latch arm 50 becomes positive in the case of αx≦α without influencing the opening operation of the latch arm, a rotational impact acts in the direction to cause the magnetic heads 17 to pivot toward the magnetic disks. If the engaging hook 63 of the carriage 22 reaches the intersection X of the circular trajectory E, it pivots to the engagement side, whereby the possibility of faulty engagement can be reduced.

Let us suppose, moreover, that Tb<Jlα is satisfied when the angular acceleration θl of the latch arm 50 is positive in the case of α0<α. If a rotational impact in the first direction acts for a long time, e.g., for 1 millisecond or more, in this case, the distal end of the latch hook 54 never fails to start moving in the first direction or to the side for engagement with the engaging hook 63 when the carriage 22 starts to move, so that a latching failure can be prevented. To attain this, the latch arm 50 and carriage 22 are formed so as to satisfy the following expression:

Tb·Jc≦Tm·Jl.

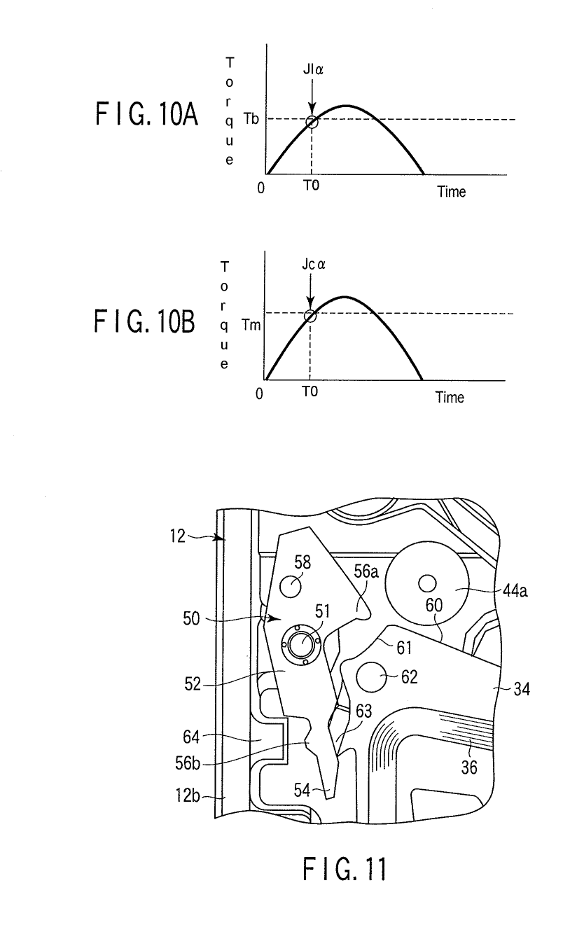

If the sign in the above expression is an equals sign, the carriage 22 and latch arm 50 start to move concurrently at T0 when a rotational impact is applied, as shown in FIGS. 10A and 10B. If the right-hand side of the above expression exceeds the left-hand side, the timing for the start of movement of the latch arm 50 exceeds that for the carriage 22, so that the latch mechanism can ensure more secure latching. As shown in FIG. 11, the engaging hook 63 of the pivoted carriage 22 engages with the latch hook 54 of the latch arm 50, whereupon the carriage is kept from pivoting further. Thus, the magnetic heads 17 can be prevented from jumping out, so that the heads, carriage, and disks can be protected against damage.

If the latch arm 50 and carriage 22 are formed so as to satisfy the relationship of the aforementioned expression, their shapes, materials, etc., are selected to adjust their moments of inertia Jl and Jc and the magnetic attractions of the first and second magnetic attraction portions 62 and 58. This adjustment can be made by, for example, suitably selecting the respective lengths and/or diameters of magnetic pins or spheres that form the magnetic attraction portions 62 and 58.

Although Tb and Tm have been described as being the magnetic attractions that act on the latch arm 50 and carriage 22, individually, the same relational expression can also be obtained if those symbols are supposed to designate torques including frictional forces. Actually, static and dynamic frictions act on the latch arm 50 and carriage 22. Therefore, Tb and Tm may be regarded individually as the sums of the static and dynamic frictions and the magnetic attractions.

According to the HDD constructed in this manner, the latch mechanism can inhibit unexpected movement of the carriage 22 and prevent the magnetic heads from being damaged by hitting the magnetic disks if an external force in any direction acts on the HDD. Even if an external rotational impact is applied for a long time in the direction to pivot the magnetic heads toward the disks when the HDD is non-operational, the latch arm 50 moves ahead of or at least simultaneously with the carriage to the engagement side. Therefore, there is no possibility of a latching failure, so that the reliability of the latch mechanism can be improved. Thus, there may be obtained a magnetic disk drive that is highly reliable against impact.

While certain embodiments of the invention have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

For example, the latch member is not limited to the form of the arm and may be variously modified. The number of magnetic disks is not limited to two and may be varied as required. Further, the magnetic disks are available in any size, e.g., 3.5, 2.5 or 1.8 inches.

What is claimed is:

1. A disk drive comprising:
a drive motor on a base configured to support and rotate a recording medium;
a carriage supporting a head configured to perform information processing with the recording medium, on the base to be pivotable around a central axis between a retracted position where the head is on an outer peripheral side of the recording medium and an information processing position where the head is on the recording medium;
a first magnetic attraction portion on the carriage configured to attract the carriage toward the retracted position;
an attaching stop on the base configured to attach to the carriage and to position the carriage in the retracted position when the carriage is moved to the retracted position; and
a latch configured to latch and hold the carriage in the retracted position when the disk drive receives an external force when the carriage is in the retracted position,
wherein the latch comprises an engaging portion on the carriage, a latching portion on the base configured to pivot around an central axis in a latchable range where the latching portion is configured to latch the engaging portion of the carriage and a released position in which the latching portion is out of a movement path of the engaging portion in order to unlatch the engaging portion, and a second magnetic attraction portion on the latching portion configured to attract the latching portion toward the released position,
the carriage and the latching portion are configured to satisfy
Tb·Jc≦Tm·Jl,
where Jc is the moment of inertia of the carriage, Jl is the moment of inertia of the latching portion, Tb is the magnetic attraction of the second magnetic attraction portion, and Tm is the magnetic attraction of the first magnetic attraction portion,
the carriage is held in the retracted position by contacting the attaching stop in a non-operational state, and the latching portion is configured to pivot in a latching direction within the latchable range before the engaging portion of the carriage starts to move when a rotational impact externally acts in a direction to pivot the carriage toward the information processing position with the latching portion contacting the carriage and in the latchable range inside a trajectory of the engaging portion.

2. The disk drive of claim 1, wherein the latching portion comprises a first contact portion configured to contact the carriage when the carriage is pivoted from the information processing position to the retracted position and to cause the latching portion to pivot from the released position to the latchable range as the carriage is pivoted, and a latch hook configured to latch the engaging portion of the carriage within the latchable range.

3. The disk drive of claim 2, wherein the latching portion comprises a support portion pivotably supported on the base, and the first contact portion and the second magnetic attraction portion are on the opposite side of the support portion from the latch hook.

4. The disk drive of claim 3, wherein the latch comprises a latch stop on the base and configured to keep the latching portion from pivoting toward the released position, and the latching portion comprises a second contact portion on the same side as the latch hook with respect to the support portion and configured to contact the latch stop when the latching portion is pivoted to the released position.

5. The disk drive of claim 4, further comprising:
a motor comprising
a magnet on the base; and
a coil on the carriage configured to pivot the carriage,
wherein the carriage comprises:
a bearing portion configured to pivot on the base;
an arm extending from the bearing portion and supporting the head; and
a support frame extending from the bearing portion and supporting the coil, and
the first and second magnetic attraction portions are at positions to be magnetically attracted by the magnet.

6. A disk drive comprising:
a drive motor on a base configured to support and rotate a disk recording medium;
a carriage supporting a head, configured to perform information processing with the recording medium, on the base to be pivotable around a central axis between a retracted position where the head is on an outer peripheral side of the recording medium and an information processing position where the head is on the recording medium;
a first magnetic attraction portion on the carriage configured to attract the carriage toward the retracted position;
an attaching stop on the base configured to attach to the carriage and to position the carriage in the retracted position when the carriage is moved to the retracted position; and
a latch configured to latch and hold the carriage in the retracted position when the disk drive receives an external force while the carriage is in the retracted position,
wherein the latch comprises an engaging portion on the carriage, a latching portion on the base is configured to pivot around a central axis in a latchable range where the latching portion is configured to latch the engaging portion of the carriage and a released position in which the latching portion is out of a movement path of the engaging portion in order to unlatch the engaging portion, and a second magnetic attraction portion on the latching portion is configured to attract the latching portion toward the released position,
the engaging portion of the carriage is configured to move along a circular trajectory around a rotational axis of the carriage and the latching portion is configured to move along a circular trajectory around a rotational axis of the latching portion,
the carriage is held in the retracted position by contacting the attaching stop in a non-operational state, the latching portion is held in the latchable range inside the circular trajectory of the engaging portion with contacting the carriage in the non-operational state, and the latching portion is arranged and configured to pivot from the position in the non-operational state toward the latchable range before the engaging portion of the carriage reaches an intersection of the respective circular trajectories of the engaging portion and the latching portion when a rotational impact externally acts in a direction to pivot the carriage toward the information processing position.
